(19) United States
(12) Patent Application Publication
(10) Pub. No.: US 2008/0074494 A1
(43) Pub. Date: Mar. 27, 2008

(54) Video Surveillance System Providing Tracking of a Moving Object in a Geospatial Model and Related Methods

(75) Inventors: Joseph M. Nemethy, West Melbourne, FL (US); Timothy B. Faulkner, Palm Bay, FL (US); Thomas J. Appolloni, Melbourne, FL (US); Joseph A. Venezia, Orlando, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/535,243

(22) Filed: Sep. 26, 2006

(51) Int. Cl. H04N 7/18

(52) U.S. Cl. 348/143

(57) ABSTRACT

A video surveillance system may include a geospatial model database for storing a geospatial model of a scene, at least one video surveillance camera for capturing video of a moving object within the scene, and a video surveillance display. The system may further include a video surveillance processor for georeferencing captured video of the moving object to the geospatial model, and for generating on the video surveillance display a georeferenced surveillance video comprising an insert associated with the captured video of the moving object superimposed into the scene of the geospatial model.

### FIELD OF THE INVENTION

The present invention relates to the field of surveillance systems, and, more particularly, to video surveillance systems and related methods.

### BACKGROUND OF THE INVENTION

Video surveillance is an important aspect of security monitoring operations. While video surveillance has long been used to monitor individual properties and buildings, its use in securing much larger geographical areas is becoming ever more important. For example, video surveillance can be a very important component of law enforcement surveillance of ports, cites, etc.

Yet, one difficulty associated with video surveillance of large geographical areas of interest is the numerous video camera feeds that have to be monitored to provide real-time, proactive security. In typical large-scale security systems, each camera is either fed into a separate video monitor, or the feed from several video cameras is selectively multiplexed to a smaller number of monitors. However, for a relatively large area, tens or even hundreds of video surveillance cameras may be required. This presents a problem not only in terms of the space required to house a corresponding number of security monitors, but it is also difficult for a limited number of security officers to monitor this many video feeds.

Still other difficulties with such systems is that they typically provide a two-dimensional view of the camera's field of vision, which may sometimes make it difficult for an operator to correctly assess the position of an object within the field of vision (particularly when zoomed out) to a desired level of accuracy. Also, it becomes difficult to track the location of moving objects throughout the geographical area of interest, as the objects keep moving between different camera fields of view and, therefore, appear on different monitors which may not be directly adjacent one another.

Various prior art approaches have been developed to facilitate video surveillance. By way of example, U.S. Pat. No. 6,295,367 discloses a system for tracking movement of objects in a scene from a stream of video frames using first and second correspondence graphs. A first correspondence graph, called an object correspondence graph, includes a plurality of nodes representing region clusters in the scene which are hypotheses of objects to be tracked, and a plurality of tracks. Each track comprises an ordered sequence of nodes in consecutive video frames that represents a track segment of an object through the scene. A second correspondence graph, called a track correspondence graph, includes a plurality of nodes, where each node corresponds to at least one track in the first correspondence graph. A track comprising an ordered sequence of nodes in the second correspondence graph represents the path of an object through the scene. Tracking information for objects, such as persons, in the scene, is accumulated based on the first correspondence graph and second correspondence graph.

Still another system is set forth in U.S. Pat. No. 6,512,857. This patent is directed to a system for accurately mapping between camera coordinates and geo-coordinates, called geo-spatial registration. The system utilizes imagery and terrain information contained in a geo-spatial database to align geographically calibrated reference imagery with an input image, e.g., dynamically generated video images, and thus achieve an identification of locations within the scene. When a sensor, such as a video camera, images a scene contained in the geospatial database, the system recalls a reference image pertaining to the imaged scene. This reference image is aligned with the sensor's images using a parametric transformation. Thereafter, other information that is associated with the reference image can be overlaid upon or otherwise associated with the sensor imagery.

Despite the advantages provided by such systems, it may still be desirable to have more control and/or tracking features for systems used to monitor a relatively large geographical area of interest and track moving objects within this area.

### SUMMARY OF THE INVENTION

In view of the foregoing background, it is therefore an object of the present invention to provide a video surveillance system providing enhanced surveillance features and related methods.

This and other objects, features, and advantages are provided by a video surveillance system which may include a geospatial model database for storing a geospatial model of a scene, at least one video surveillance camera for capturing video of a moving object within the scene, and a video surveillance display. The system may further include a video surveillance processor for georeferencing captured video of the moving object to the geospatial model, and for generating on the video surveillance display a georeferenced surveillance video comprising an insert associated with the captured video of the moving object superimposed into the scene of the geospatial model.

The processor may permit user selection of a viewpoint within the georeferenced surveillance video. Also, the at least one video camera may include one or more fixed or moving video cameras. In particular, the at least one video surveillance camera may include a plurality of spaced-apart video surveillance cameras for capturing a three-dimensional (3D) video of the moving object.

The insert may include the captured 3D video insert of the moving object. The insert may further or alternatively include an icon representative of the moving object. In addition, processor may associate an identification flag and/or a projected path with the moving object for surveillance despite temporary obscuration within the scene. By way of example, the at least one video camera may be at least one of an optical video camera, an infrared video camera, and a scanning aperture radar (SAR) video camera. Moreover, the geospatial model database may be a three-dimensional (3D) model, such as a digital elevation model (DEM), for example.

A video surveillance method aspect may include storing a geospatial model of a scene in a geospatial model database, capturing video of a moving object within the scene using at least one video surveillance camera, and georeferencing the captured video of the moving object to the geospatial model. The method may further include generating on a video surveillance display a georeferenced surveillance video comprising an insert associated with the captured video of the moving object superimposed into the scene of the geospatial model.

### BRIEF DESCRIPTION OF THE DRAWINGS

FIG. 1 is a schematic block diagram of a video surveillance system in accordance with the invention.

FIGS. 2 and 3 are screen prints of a georeferenced surveillance video including a geospatial model and an insert associated with captured video of a moving object superimposed into the geospatial model in accordance with the invention.

FIGS. 4 and 5 are schematic block diagrams of buildings obscuring a moving object and illustrating object tracking features of the system of FIG. 1.

FIG. 6 is a flow diagram of a video surveillance method in accordance with the present invention.

FIG. 7 is a flow diagram illustrating video surveillance method aspects of the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

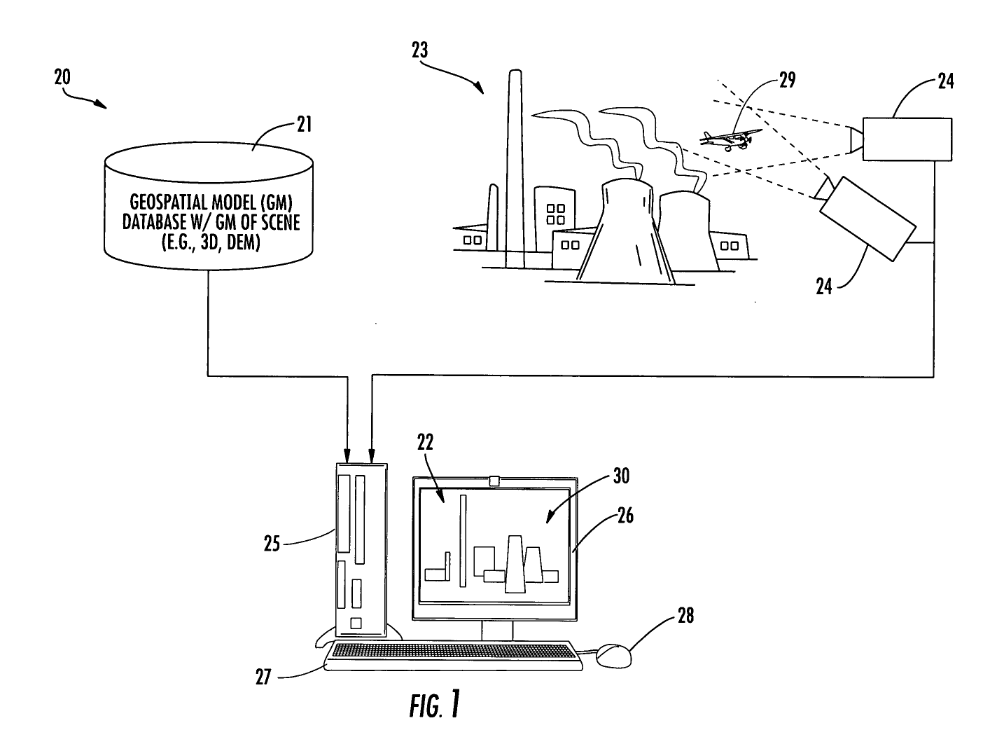

Referring initially to FIG. 1, a video surveillance system 20 illustratively includes a geospatial model database 21 for storing a geospatial model 22, such as a three-dimensional (3D) digital elevation model (DEM), of a scene 23. One or more video surveillance cameras 24 are for capturing video of a moving object 29 within the scene 23. In the illustrated embodiment, the moving object 29 is a small airplane, but other types of moving objects may be tracked using the system 20 as well. Various types of video cameras may be used, such as optical video cameras, infrared video cameras, and/or scanning aperture radar (SAR) video cameras, for example. It should be noted that, as used herein, the term “video” refers a sequence of images that changes in real time,

The system 20 further illustratively includes a video surveillance processor 25 and a video surveillance display 26. By way of example, the video surveillance processor 25 may be a central processing unit (CPU) of a PC, Mac, or other computing workstation, for example. Generally speaking, the video surveillance processor 25 is for georeferencing captured video of the moving object 29 to the geospatial model 22, and for generating on the video surveillance display 26 a georeferenced surveillance video comprising an insert 30 associated with the captured video of the moving object superimposed into the scene 23 of the geospatial model.

In the illustrated embodiment, the insert 30 is an icon (i.e., a triangle or flag) superimposed into the geospatial model 22 at a location corresponding to the location of the moving object 29 within the scene 23. In particular, the location of the camera 24 will typically be known, either because it is at a fixed position or, in the case of a moving camera, will have a position location device (e.g., GPS) associated therewith. Moreover, a typical video surveillance camera may be configured with associated processing circuitry or calibrated so that it outputs only the group of moving pixels within a scene. In addition, the camera may also be configured with associated processing circuitry or calibrated so that it provides a range and bearing to the moving object 29. The processor 25 may thereby determine the location of the moving object 29 in terms of latitude/longitude/elevation coordinates, for example, and superimpose the insert 30 at the appropriate latitude/longitude/elevation position within the geospatial model 22, as will be appreciated by those skilled in the art.

It should be noted that portions of the processing operations may be performed outside the single CPU illustrated in FIG. 1. That is, the processing operations described herein as being performed by the processor 29 may be distributed amongst several different processors or processing modules, including a processor/processing module associated with the camera(s) 24.

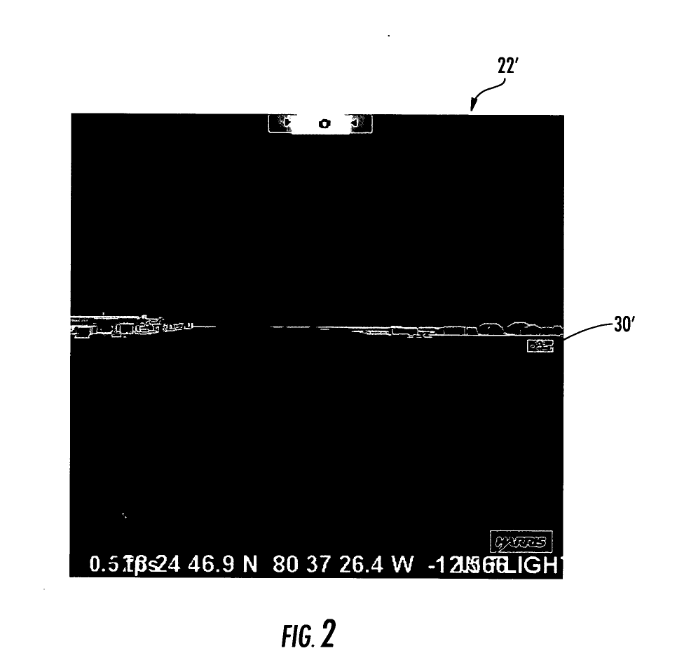

Referring now to an alternative embodiment illustrated in FIGS. 2 and 3, the insert 30′ may be an actual captured video insert of the moving object from the camera 24. In the illustrated embodiment, the scene is of a port area, and the moving object is a ship moving on the water within the port. If a plurality of spaced-apart video surveillance cameras 24 are used, a 3D video of the moving object may be captured and displayed as the insert 30′. The insert may be framed in a box as a video “chip” as shown, or in some embodiments it may be possible to show less of the video pixels surrounding the moving object, as will be appreciated by those skilled in the art.

In addition to being able to view an actual video insert of the moving object, another particularly advantageous feature is also shown in the present embodiment, namely the ability of the user to change viewpoints. That is, the processor 25 may advantageously permit user selection of a viewpoint within the georeferenced surveillance video. Here, in FIG. 2 the viewpoint is from a first location, and in FIG. 3 the viewpoint is from a second, different location than the first location, as shown by the coordinates at the bottom of the georeferenced surveillance video.

Moreover, the user may also be permitted to change the zoom ratio of the georeferenced surveillance video. As seen in FIG. 3, the insert 30′ appears larger than in FIG. 2 because a larger zoom ratio is used. A user may change the zoom ratio or viewpoint of the image using an input device such as a keyboard 27, mouse 28, joystick (not shown), etc. connected (either by wired or wireless connection) to the processor 25, as will be appreciated by those skilled in the art.

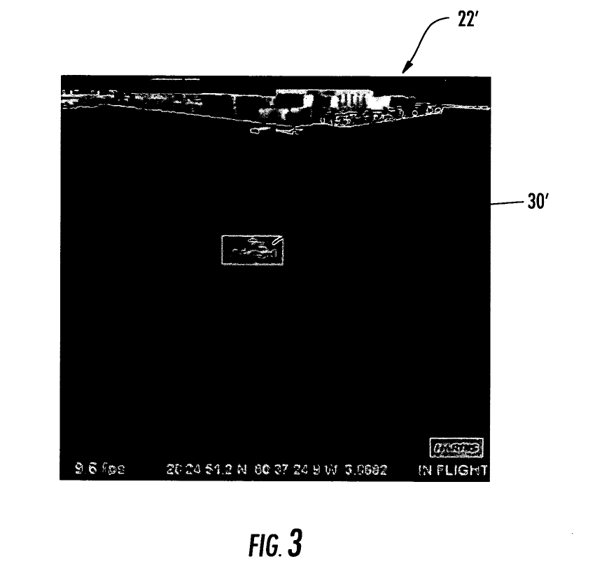

Turning additionally to FIGS. 4 and 5, additional features for displaying the georeferenced surveillance video are now described. In particular, these features relate to providing an operator or user of the system 20 the ability to track moving objects that would otherwise be obscured by other objects in the scene. For example, the processor 25 may associate an actual or projected path 35″ with the insert 30″ when the insert would otherwise pass behind an object 36″ in the geospatial model, such as a building. In other words, the camera angle to the moving object is not obscured, but the moving object is obscured from view because of the current viewpoint of the scene.

In addition to, or instead of, the projected path 35″ displayed by the processor 25, a video insert 30′″ may be displayed as an identification flag/icon that is associated with the moving object for surveillance despite temporary obscuration within the scene. In the example illustrated in FIG. 5, when the moving object (i.e., an aircraft) goes being the building 36′″, the insert 30′″ may change from the actual captured video insert shown in FIG. 4 to the flag shown with dashed lines in FIG. 5 to indicate that the moving object is behind the building.

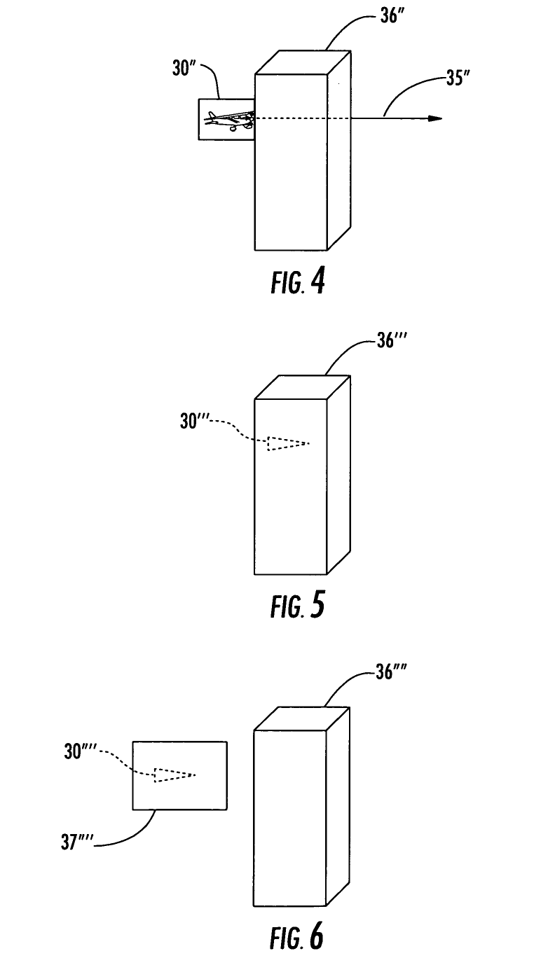

In accordance with another advantageous aspect illustrated in FIG. 6, the processor 25 may display an insert 30″″ (e.g., a flag/icon) despite temporary obscuration of the moving object from the video camera 24. That is, the video camera 24 has an obscured line of sight to the moving object, which is illustrated by a dashed rectangle 37″″ in FIG. 6. In such case, an actual or projected path may still be used, as described above. Moreover, the above-described techniques may be used where both camera or building, etc. obscuration occurs, as will be appreciated by those skilled in the art.

Another potentially advantageous feature is the ability to generate labels for the insert 30. More particularly, such labels may be automatically generated and displayed by the processor 25 for moving objects 29 within the scene 23 that are known (e.g., a marine patrol boat, etc.), which could be determined based upon a radio identification signal, etc., as will be appreciated by those skilled in the art. On the other hand, the processor 25 could label unidentified objects as such, and generate other labels or warnings based upon factors such as the speed of the object, the position of the object relative to a security zone, etc. Moreover, the user may also have the ability to label moving objects using an input device such as the keyboard 27.

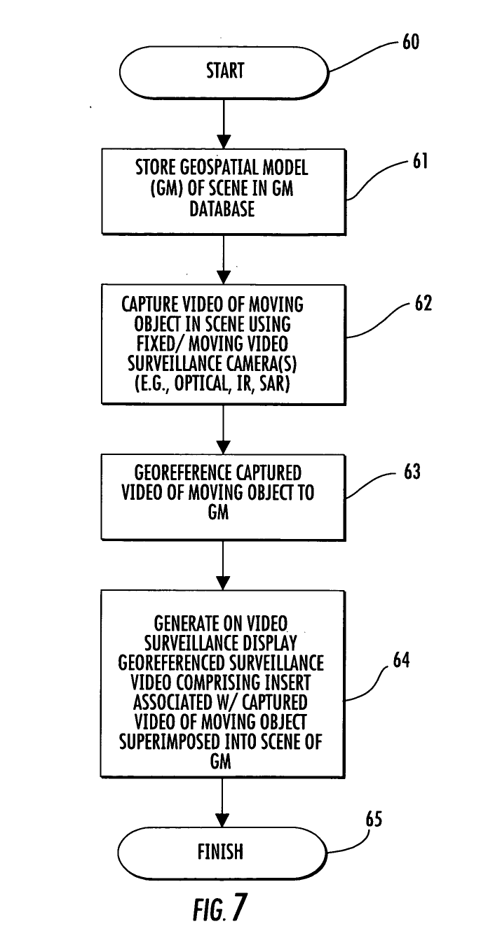

A video surveillance method aspect is now described with reference to FIG. 7. Beginning at Block 60, a geospatial model 22 of a scene 23 is stored in the geospatial model database 21, at Block 61. It should be noted that the geospatial model (e.g., DEM) may be created by the processor 25 in some embodiments, or it may be created elsewhere and stored in the database 21 for further processing. Also, while the database 21 and processor 25 are shown separately in FIG. 1 for clarity of illustration, these components may be implemented in a same computer or server, for example.

The method further illustratively includes capturing video of a moving object 29 within the scene 23 using one or more fixed/moving video surveillance cameras 24, at Block 62. Moreover, the captured video of the moving object 29 is georeferenced to the geospatial model 22, at Block 63. Furthermore, a georeferenced surveillance video is generated on a video surveillance display 26 which includes an insert 30 associated with the captured video of the moving object 29 superimposed into the scene of the geospatial model 22, at Block 64, as discussed further above, thus concluding the illustrated method (Block 65).

The above-described operations may be implemented using a 3D site modeling product such as RealSite®, and/or a 3D visualization tool such as InReality®, both of which are from the present Assignee Harris Corp. RealSite® may be used to register overlapping images of a geographical area of interest, and extract high resolution DEMs using stereo and nadir view techniques. RealSite® provides a semi-automated process for making three-dimensional (3D) topographical models of geographical areas, including cities, that have accurate textures and structure boundaries. Moreover, RealSite® models are geospatially accurate. That is, the location of any given point within the model corresponds to an actual location in the geographical area with very high accuracy. The data used to generate RealSite® models may include aerial and satellite photography, electro-optical, infrared, and light detection and ranging (LIDAR). Moreover, InReality® provides sophisticated interaction within a 3-D virtual scene. It allows a user to easily move through a geospatially accurate virtual environment with the capability of immersion at any location within a scene.

The system and method described above may therefore advantageously use a high resolution 3D geospatial model to track moving objects from video camera(s) to cerate a single point of viewing for surveillance purposes. Moreover, inserts from several different video surveillance cameras may be superimposed in the georeferenced surveillance video, with real or near real-time updates of the inserts.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A video surveillance system comprising:
a geospatial model database for storing a geospatial model of a scene;
at least one video surveillance camera for capturing video of a moving object within the scene;
a video surveillance display; and
a video surveillance processor for georeferencing captured video of the moving object to the geospatial model, and generating on said video surveillance display a georeferenced surveillance video comprising an insert associated with the captured video of the moving object superimposed into the scene of the geospatial model.

2. The video surveillance system of claim 1 wherein said processor permits user selection of a viewpoint within the georeferenced surveillance video.

3. The video surveillance system of claim 1 wherein said at least one video surveillance camera comprises a plurality of spaced-apart video surveillance cameras for capturing a three-dimensional (3D) video of the moving object.

4. The video surveillance system of claim 3 wherein the insert comprises the captured 3D video insert of the moving object.

5. The video surveillance system of claim 1 wherein the insert comprises an icon representative of the moving object.

6. The video surveillance system of claim 1 wherein said processor associates an identification flag with the moving object for surveillance despite temporary obscuration within the scene.

7. The video surveillance system of claim 1 wherein said processor associates a projected path with the moving object for surveillance despite temporary obscuration of the at least one video camera.

8. The video surveillance system of claim 1 wherein said at least one video camera comprises at least one fixed video camera.

9. The video surveillance system of claim 1 wherein said at least one video camera comprises at least one moving video camera.

10. The video surveillance system of claim 1 wherein said at least one video camera comprises at least one of an optical video camera, an infrared video camera, and a scanning aperture radar (SAR) video camera.

11. The video surveillance system of claim 1 wherein the geospatial model database comprises a digital elevation model (DEM) database.

12. The video surveillance system of claim 1 wherein the geospatial model comprises a three-dimensional (3D) model.

13. A video surveillance system comprising:
a geospatial model database for storing a three-dimensional (3D) geospatial model of a scene;
a video surveillance display; and
a video surveillance processor for georeferencing captured video of a moving object to the 3D geospatial model, and generating on said video surveillance display a georeferenced surveillance video comprising an insert associated with the moving object superimposed into the scene of the 3D geospatial model.

14. The video surveillance system of claim 13 wherein said at least one video surveillance camera comprises a plurality of spaced-apart video surveillance cameras for capturing a three-dimensional (3D) video of the moving object.

15. The video surveillance system of claim 13 wherein said processor associates at least one of an identification flag and a projected path with the moving object for surveillance despite temporary obscuration within the scene.

16. The video surveillance system of claim 13 wherein the geospatial model database comprises a digital elevation model (DEM) database.

17. A video surveillance method comprising:
storing a geospatial model of a scene in a geospatial model database;
capturing video of a moving object within the scene using at least one video surveillance camera;
georeferencing the captured video of the moving object to the geospatial model; and
generating on a video surveillance display a georeferenced surveillance video comprising an insert associated with the captured video of the moving object superimposed into the scene of the geospatial model.

18. The method of claim 17 wherein the at least one video surveillance camera comprises a plurality of spaced-apart video surveillance cameras for capturing a three-dimensional (3D) video of the moving object.

19. The method of claim 17 wherein the insert comprises at least one of the captured 3D video insert of the moving object and an icon representative of the moving object.

20. The method of claim 17 wherein the processor associates at least one of an identification flag and a projected path with the moving object for surveillance despite temporary obscuration within the scene.

21. The method of claim 17 wherein the geospatial model database comprises a digital elevation model (DEM) database.
